(19) United States
(12) Patent Application Publication
(10) Pub. No.: US 2009/0110281 A1
(43) Pub. Date: Apr. 30, 2009

(54) IMAGE FORMING APPARATUS, IMAGE PROCESSING APPARATUS, AND IMAGE PROCESSING METHOD

(75) Inventor: Kazunori Hirabayashi, Shizuoka-ken (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/137,726

(22) Filed: Jun. 12, 2008

Related U.S. Application Data
(60) Provisional application No. 60/983,424, filed on Oct. 29, 2007.

(51) Int. Cl. G06K 9/34

(52) U.S. Cl. 382/180

(57) ABSTRACT

An image forming apparatus that processes image data using plural processors that operate in parallel includes an image-data receiving section that receives inputted image data, a layout analyzing section that analyzes a layout structure including a predetermined area on the basis of the image data received by the image-data receiving section, a processing-amount calculating section that calculates a processing amount for the predetermined area in the layout structure of the image data analyzed by the layout analyzing section, and a processing-processor determining section that allocates, in processing for all areas in the layout structure analyzed by the layout analyzing section, processing for the predetermined areas to any one of the plural processors on the basis of the processing amount calculated by the processing-amount calculating section.

### BACKGROUND OF THE INVENTION

1. Field of the Invention

The present invention relates to a scheduling technique for plural processors in a layout analysis.

2. Description of the Background

Conventionally, there is known a technique for analyzing, in a function of scanning a paper document with a scanning function of an MFP to create an electric document, a layout of scanned image data to thereby extract a character area, a background area, an image area, and the like and selecting a compression method most suitable for the respective extracted areas to simultaneously realize improvement of efficiency of compression of scanning data and visibility. This technique is a technique, for example, for an area extracted as the character area by the layout analysis the shape of the character is compressed using binary compression techniques such as MMR, JBIG, or JBI2 and an area extracted as the background area or an image area such as a photograph or a picture by the layout analysis is compressed using a compression technique such as JPEG, JPEG2000, or HD Photo. The respective areas compressed by these different compression systems are merged. Consequently, it is possible to prevent deterioration in visibility of an image in a high-frequency portion due to the compression of the character area by JPEG or the like. It is also possible to create an image generally having high compression efficiency.

There is also known a technique for applying OCR or the like to an area extracted as a character area and converting only the character area into a document.

As a technique related to the present invention, there are known an image processing apparatus that allocates plural colors to a character area, an image processing method for the image processing apparatus, and a storage medium for the image processing method (JP-A-2003-008909).

However, the processing such as the layout analysis, the image processing for the respective areas, and the OCR described above is heavily-loaded and time-consuming processing. In addition, according to the improvement of accuracy of the layout analysis and the character recognition and an image quality of electronic document to be created, a processing amount further increases. As a result, relatively long time is required until the electronic document is obtained.

To cope with such a problem, there is known a technique for, instead of sequentially performing these kinds of processing, using plural processors or multi-core processors, allocating processing for each of the areas to the respective processors, and parallelizing the processing to reduce processing time.

However, processing times for the respective areas are different and are not fixed in the parallization of the processing for each of the areas. In order to efficiently use plural calculation resources, it is necessary to schedule loads of processing for the respective calculation resources with good balance.

### SUMMARY OF THE INVENTION

It is an object of an embodiment of the present invention to provide a technique that can efficiently allocate processing for respective areas extracted by a layout analysis to plural calculation resources.

In order to solve the problem, an image forming apparatus according to an aspect of the present invention is an apparatus that processes image data using plural processors that operate in parallel. The image forming apparatus includes an image-data receiving section that receives inputted image data, a layout analyzing section that analyzes a layout structure including a predetermined area on the basis of the image data received by the image-data receiving section, a processing-amount calculating section that calculates a processing amount for the predetermined area in the layout structure of the image data analyzed by the layout analyzing section, and a processing-processor determining section that allocates, in processing for all areas in the layout structure analyzed by the layout analyzing section, processing for the predetermined areas to any one of the plural processors on the basis of the processing amount calculated by the processing-amount calculating section.

An image processing apparatus according to another aspect of the present invention is an apparatus that processes image data using plural processors that operate in parallel. The image processing apparatus includes an image-data receiving section that receives inputted image data, a layout analyzing section that analyzes a layout structure including a predetermined area on the basis of the image data received by the image-data receiving section, a processing-amount calculating section that calculates a processing amount for the predetermined area in the layout structure of the image data analyzed by the layout analyzing section, and a processing-processor determining section that allocates, in processing for all areas in the layout structure analyzed by the layout analyzing section, processing for the predetermined area to any one of the plural processors on the basis of the processing amount calculated by the processing-amount calculating section.

An image processing method according to still another aspect of the present invention is a method of processing image data using plural processors that operate in parallel. The image processing method includes receiving inputted image data, analyzing a layout structure including a predetermined area on the basis of the received image data, calculating a processing amount for the predetermined area in the analyzed layout structure of the image data, and allocating, in processing for all areas in the analyzed layout structure, processing for the predetermined area to any one of the plural processors on the basis of the calculated processing amount.

### BRIEF DESCRIPTION OF THE DRAWINGS

FIG. 1 is a block diagram showing a controller according to a first embodiment of the present invention;

FIG. 2 is a functional block diagram in a processor according to the first embodiment;

FIG. 3 is a diagram of image data analyzed in the first embodiment;

FIG. 4 is a diagram of an analysis result of the image data in the first embodiment;

FIG. 5 is a table showing an example of a calculation of evaluation values for parameters;

FIG. 6 is a diagram showing an example of scheduling for processing;

FIG. 7 is a flowchart showing operations of allocation processing;

FIG. 8 is a functional block diagram in a processor according to a second embodiment;

FIG. 9 is a diagram showing an example of degrees of importance added to respective parameters; and

FIG. 10 is a flowchart showing operations of degree-of-importance determining processing.

### DESCRIPTION OF THE EMBODIMENTS

Embodiments of the present invention will be hereinafter explained with reference to the accompanying drawings.

### First Embodiment

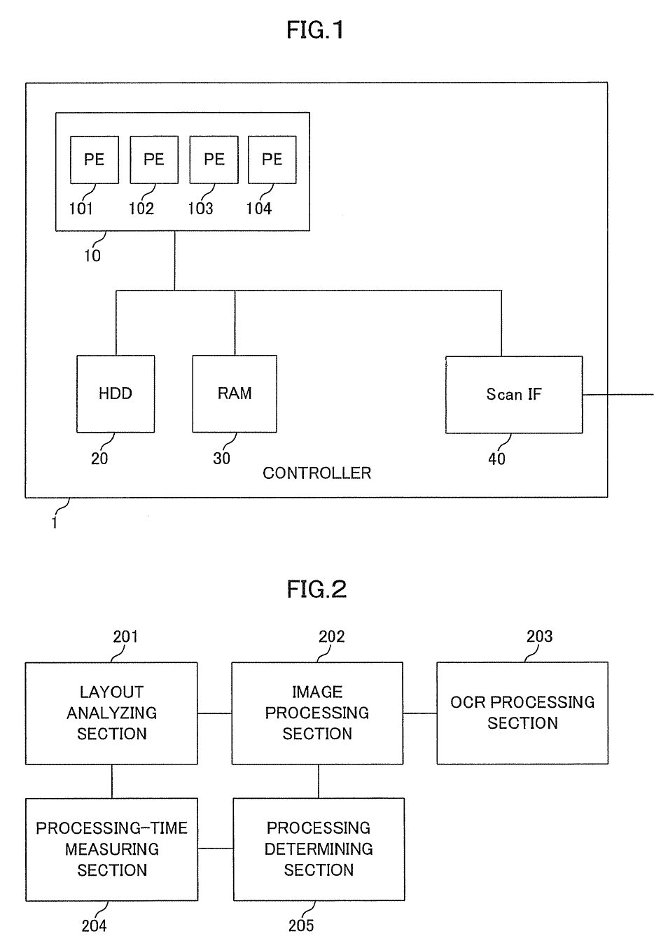

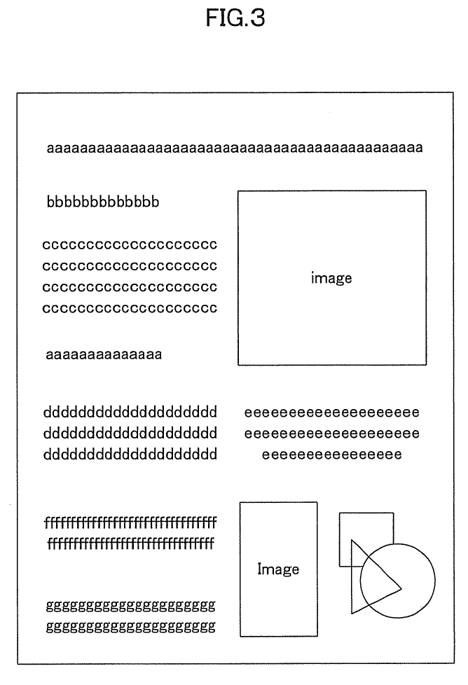

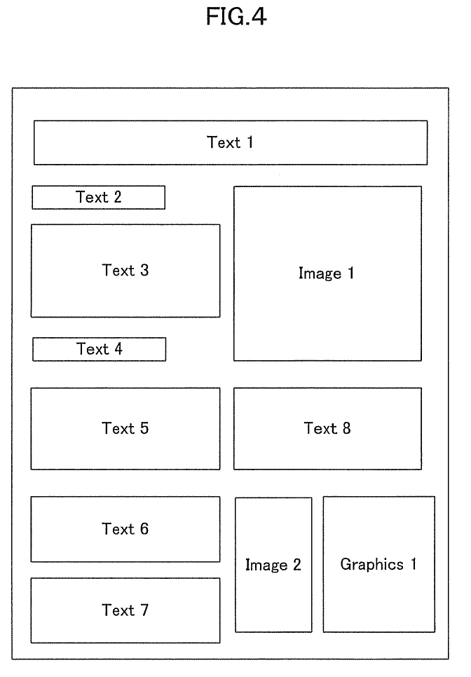

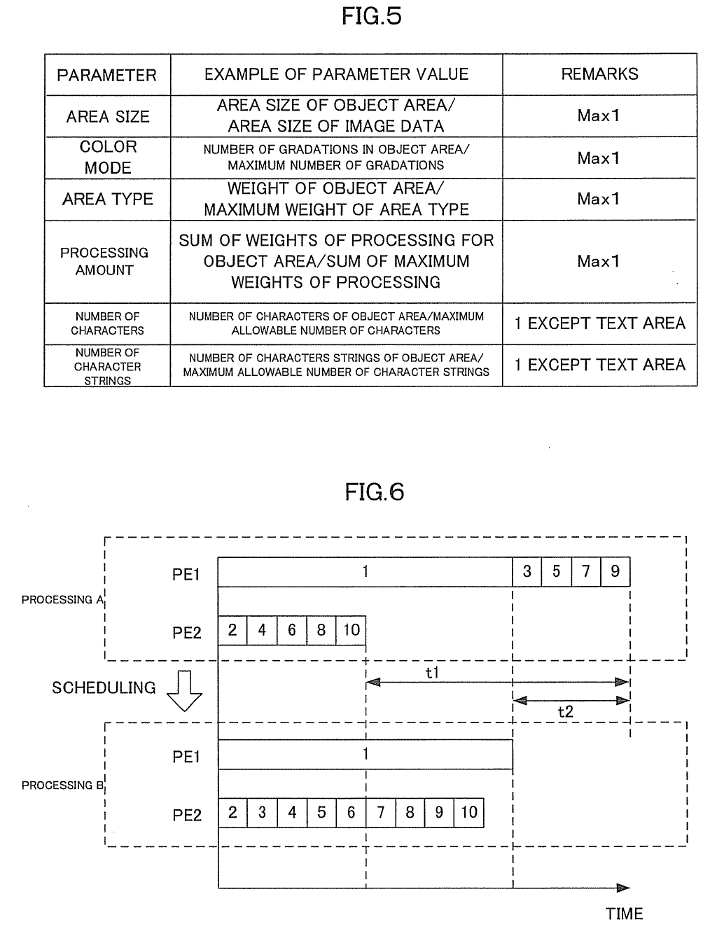

FIG. 1 is a block diagram showing a controller according to a first embodiment of the present invention. FIG. 2 is a functional block diagram in a processor according to the first embodiment. FIG. 3 is a diagram of image data analyzed in the first embodiment. FIG. 4 is a diagram of an analysis result of the image data in the first embodiment. FIG. 5 is a table showing an example of a calculation of evaluation values for parameters. FIG. 6 is a diagram showing an example of scheduling for processing.

As shown in FIG. 1, a controller 1 is a controller (an image processing apparatus) for controlling an MFP (Multifunction Printer; an image forming apparatus) and includes a processor 10 (plural processors), an HDD (Hard Disk Drive) 20, a RAM (Random Access Memory) 30, and a scan IF (interface) 40 (an image-data receiving section). The processor 10 performs image processing and processing for control of the MFP. The HDD 20 stores settings, programs, and the like for the image processing and the control of the MFP. The RAM 30 temporarily stores data and programs for the processing by the processor 10. The scan IF 40 is an interface for inputting image data captured by a scanner of the MFP to the controller 1.

The processor 10 is a symmetrical multiprocessor including four equivalent PEs (Processor elements) 101 to 104. The processor 10 may be a multi-core processor. The multi-core processor may be a heterogeneous processor or may be a homogenous processor. The processor 10 may be an asymmetrical multiprocessor. The number of PEs of the processor 10 may be any number as long as there are plural PEs.

The processor 10 includes a layout analyzing section 201 (a processing-amount calculating section), an image processing section 202, an OCR processing section 203, a processing-time measuring section 204, and a processing determining section 205 (a processing-processor determining section) shown in FIG. 2. Specifically, the layout analyzing section 201, the image processing section 202, the OCR processing section 203, the processing-time measuring section 204, and the processing determining section 205 are programs. The programs are stored in the HDD 20 and a storage medium such as a flash ROM, loaded onto the RAM 30 when necessary, and executed by the processor 10. In the execution of the programs, the respective sections shown in FIG. 2 are executed independently from one another on the PEs 101 to 104. The respective sections shown in FIG. 2 are explained below.

First, the layout analyzing section 201 is explained. The layout analyzing section 201 analyzes a layout structure of image data inputted by the scan IF 40. Specifically, the layout analyzing section 201 analyzes image data including areas of sentences and images shown in FIG. 3 and discriminates types of the respective areas, i.e., whether the respective areas are areas of characters, an image, and graphics as shown in FIG. 4. For example, in discriminating whether a certain area is an image area or a graphics area, the layout analyzing section 201 discriminates a rectangular area like a photograph as an image area and discriminates a non-rectangular area like a graph as a graphics area. The layout analyzing section 201 may discriminate whether a certain area is an image area or a graphics area on the basis of the number of colors in the area.

A specific example of an analysis of a character area by the layout analyzing section 201 is described below.

First, the layout analyzing section 201 generates a histogram for image data subjected to luminance conversion and calculates a threshold from the histogram. Then, the layout analyzing section 201 binarizes the image data on the basis of the threshold, identifies characters in the binarized image data using edge extraction and labeling processing, and extracts the characters. Finally, the layout analyzing section 201 discriminates character areas on the basis of intervals among the extracted characters.

After discriminating types of the areas described above, the layout analyzing section 201 further analyzes each of the areas and calculates parameter values for each of the areas. Examples of the parameter values to be calculated include, as shown in FIG. 5, an area size (an area size of an area or an area size of image data), a color mode (the number of gradations in an area or a maximum number of gradations that can be treated in the MFP), an area type (a processing amount of a type of an area or a processing amount of a heaviest type), a processing amount (a sum of amounts of processing executed on an area or a sum of heaviest processing), the number of characters (the number of characters in an area or a maximum allowable number of characters), and the number of character strings (the number of character strings in an area or a maximum allowable number of character strings). The processing amount of a type of an area or the processing amount of a heaviest type in the area type and the sum of amounts of processing executed on an area or the sum of heaviest processing in the processing amount are calculated by the processing-time measuring section 204. A method of calculating these parameter values is described later.

These parameter values are values normalized between 0 and 1 as indicated by remarks in FIG. 5. Values of the number of characters and the number of character strings are unconditionally 1 when the area is not a character area. The layout analyzing section 201 calculates an evaluation value for the area by multiplying all of these values together. Therefore, these values do not affect the evaluation value if the parameter values of the number of characters and the number of character strings are set to 1 when the area is not a character area. The evaluation value for the area calculated by the layout analyzing section 201 is also a result of multiplication of the parameter values normalized between 0 and 1. Therefore, if the parameter values are values normalized between 0 and 1, it is possible to reduce burdens of processing related to processing weight of the area. The evaluation value indicates that, as the value is higher, processing for an object area is heavier and, as the value is lower, processing for the object area is lighter.

The image processing section 202 and the OCR processing section 203 are explained. The image processing section 202 applies image processing to each of the areas analyzed by the layout analyzing section 201. Specifically, the image processing section 202 executes compression and filter processing by a system that does not spoil visibility of an area allocated thereto. For example, when a type of the area is an image, the image processing section 202 compresses the area with JPEG. When a type of the area is graphics, the image processing section 202 compresses the area with GIF. When a type of the area is a character and OCR is not executed, the image processing section 202 compresses the area with a binary compression technique such as MMR. The OCR processing section 203 executes OCR on a character area. The image processing section 202 and the OCR processing section 203 execute the processing described above on the basis of an instruction of the processing determining section 205. When processing for all the area in the image data is completed, the image processing section 202 finally merges all the areas.

The processing-time measuring section 204 is explained. The processing-time measuring section 204 measures time of the processing by the image processing section 202 and the OCR processing section 203 and stores the measured processing time, i.e., a processing amount in each of the PEs 101 to 104, in the HDD 20. In this embodiment, since the PEs 101 to 104 are the same PEs, the processing-time measuring section 204 may measure a processing load. However, when the processor 10 includes different PEs, it is necessary to measure processing time.

The processing-time measuring section 204 calculates the “weight of an object area”, the “maximum weight of an area type”, the “sum of weights of processing for an object area”, and the “sum of maximum weight of processing” shown in FIG. 5 from the measured and stored processing amount and stores the parameter values in the HDD 20. The “weight of an object area” and the “maximum weight of an area type” are calculated by calculating an average of processing amounts in the past for each of areas (a character area, an image area, and a graphics area). For example, when an object for which parameter values are calculated is an image area and an area having a highest average of processing amounts is a character area, the “weight of an object area” is an average of processing amounts of the image area and the “maximum weight of an area type” is an average of processing amounts of the character area. The “sum of weights of processing for an object area” and the “sum of maximum weight of processing” are calculated by calculating a sum of processing amounts in the past for each of various compression processing and OCR processing. For example, when an object for which parameter values are calculated is an image area and processing with a largest sum of processing amounts is OCR processing, the “sum of weights of processing for an object area” is a sum of processing amounts of JPEG compression and the “sum of maximum weight of processing” is a sum of processing amounts of OCR processing.

The processing determining section 205 is explained. The processing determining section 205 performs scheduling for processing. Specifically, the processing determining section 205 allocates the various kinds of compression processing and the OCR processing to the respective PEs 101 to 104. Scheduling for the processing is explained below with reference to FIG. 6. It is assumed that, in processing A and processing B that are different kinds of scheduling processing in FIG. 6, various kinds of processing indicated by 1 to 10 are performed by two PEs, i.e., a PE 1 and a PE 2. In FIG. 6, processing 1 is processing that takes one second and the processing 2 to processing 10 are kind of processing that take 0.1 second.

The processing A shown in FIG. 6 is processing for alternately allocating the respective kinds of processing 1 to 10 without taking into account processing times for the respective kinds of processing 1 to 10 in such a manner that the processing 1 is allocated to the PE 1, the processing 2 is allocated to the PE 2, and the processing 3 is allocated to the PE 1. However, since time for the processing 1 is different from time for the processing 2 to 10, a sum of processing times in the PE 1 is finally 1.4 seconds and a sum of processing times in the PE 2 is 0.5 second. As a result, there is a difference of 0.9 second between the sum of processing times in the PE 1 and the sum of processing times in the PE 2. Because of this difference, the PE 2 waits without performing any processing until the processing in the PE 1 is finished. As the difference between the sum of processing times in the PE 1 and the sum of processing times in the PE 2 is larger, processing time for the processing 1 to the processing 10 increases.

On the other hand, the processing B is scheduling processing for allocating the processing 1 to the processing 10 taking into account processing times of the processing 1 to the processing 10 to minimize a difference between a sum of processing times in the PE 1 and a sum of processing times in the PE 2. By allocating the processing 1 to the processing 10 to the PE 1 and the PE 2 in this way, it is possible to reduce overall processing time by 0.4 second compared with that in the processing A.

The processing determining section 205 performs scheduling taking into account processing time of each of the processing 1 to the processing 10 to minimize a difference in processing time among the PEs 101 to 104.

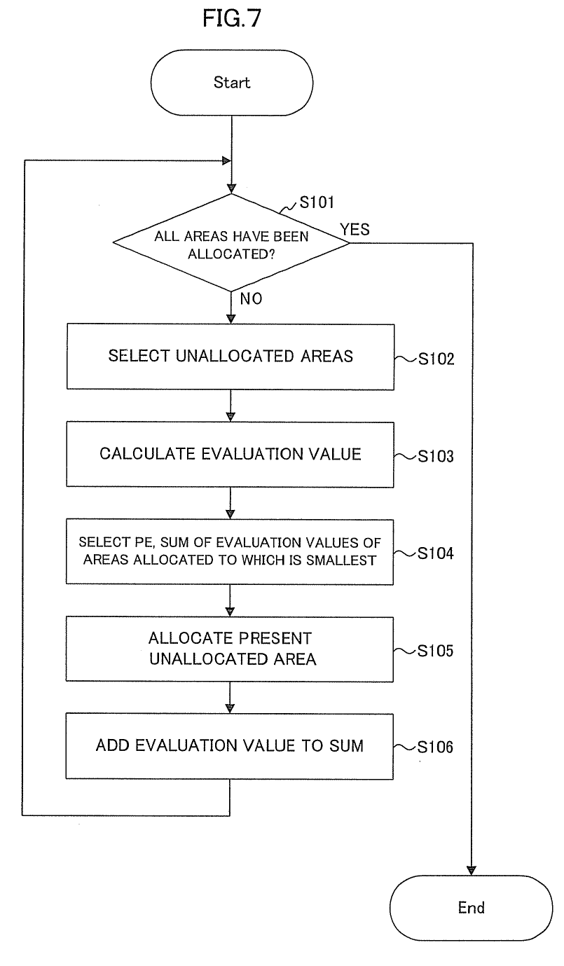

Allocation processing according to this embodiment is explained. FIG. 7 is a flowchart showing operations of the allocation processing. In FIG. 7, it is assumed that a layout structure of image data has already been analyzed. In FIG. 7, it is assumed that an area indicates processing for the area.

First, the processing determining section 205 determines whether all areas are allocated to the PEs 101 to 104 (S101).

When there are areas hot allocated to the PEs 101 to 104 (unallocated areas) (S101, NO), the processing determining section 205 selects any one of the unallocated areas (S102).

When the unallocated area is selected by the processing determining section 205, the layout analyzing section 201 calculates an evaluation value of the unallocated area selected by the processing determining section 205 (S103).

When the evaluation value of the unallocated area is calculated by the layout analyzing section 201, the processing determining section 205 selects a PE, a sum of evaluation values of areas already allocated to which is the smallest, among the PEs 101 to 104 (S104), allocates the unallocated area to the selected PE (S105), adds the evaluation value of the allocated area to the sum of evaluation values of areas already allocated to the PE (S106), and determines again whether all the areas are allocated to any one of PEs 101 to 104 (S101).

When all the areas are allocated to any one of the PEs 101 to 104 in step S101 (S101, YES), the processing determining section 205 finishes the allocation processing for the image data.

As described above, the controller 1 according to this embodiment can perform the processing for the respective areas of the image data at high speed by calculating processing loads on the respective areas and allocating the processing for the respective areas to the PEs 101 to 104 taking into account the calculated processing loads to minimize a difference in a sum of processing loads among the PEs 101 to 104.

### Second Embodiment

A second embodiment of the present invention is explained.

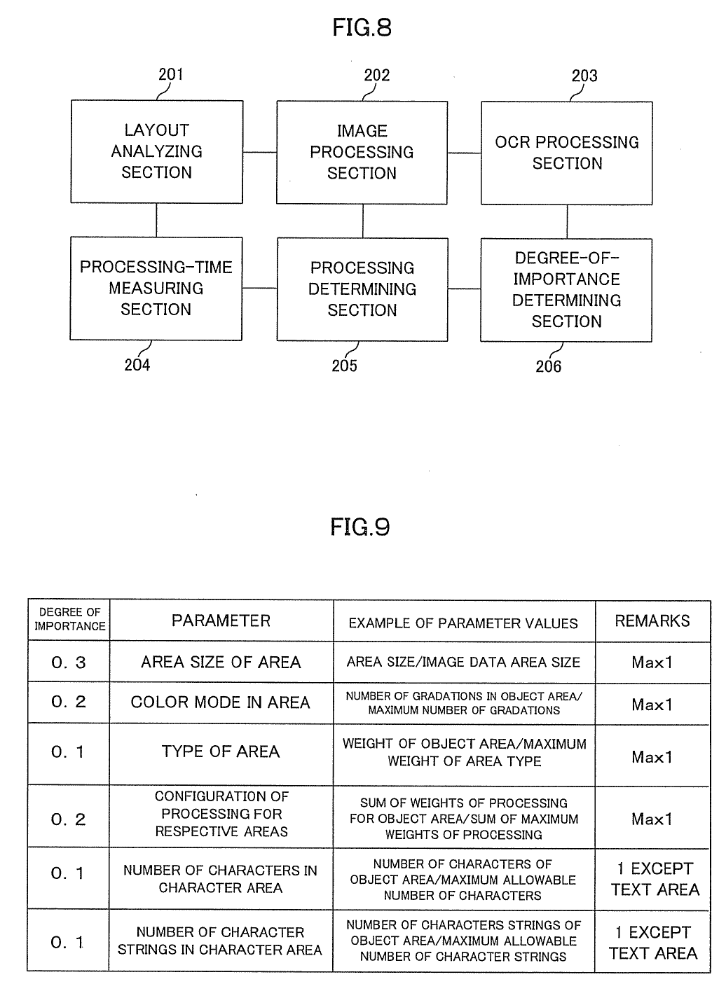

This embodiment is different from the first embodiment in that a degree of importance as a weighting coefficient is added to respective parameters for compression and OCR processing for each of areas and an evaluation value of processing for the area is calculated by taking into account the degree of importance. According to the difference from the first embodiment, components and operations for functions executed on the processing processor 10 are different from those in the first embodiment. The components and the operations different from those in the first embodiment are explained below. FIG. 8 is a functional block diagram in a controller according to the second embodiment. FIG. 9 is a diagram showing an example of degrees of importance added to the respective parameters.

As shown in FIG. 8, the processor 10 is different from that according to the first embodiment in that the processor 10 includes, in addition to the layout analyzing section 201, the image processing section 202, the OCR processing section 203, the processing-time measuring section 204, and the processing determining section 205, a degree-of-importance determining section 206 (a degree-of-importance changing section). The degree-of-importance determining section 206 determines degrees of importance added to respective parameters compression and OCR processing for each of areas shown in FIG. 9.

The degree of importance is explained. The degree of importance is a value added to each of the parameters and normalized to 0 to 1 in the same manner as an evaluation value. The degree of importance is a value for weighting all the parameters indicated by 0 to 1. The degree of importance is determined by the degree-of-importance determining section 206 for each kind of processing for image data. A more appropriate evaluation value of processing for each of the areas is calculated by adjusting the value of the degree of importance.

In this embodiment, operations of the image processing section 202, the OCR processing section 203, the processing-time measuring section 204, and the processing determining section 205 are the same as those in the first embodiment. However, operations of the layout analyzing section 201 are different from those in the first embodiment. Specifically, the operations of the layout analyzing section 201 are different from those in the first embodiment in that, in calculating an evaluation value of processing for each of the areas, the layout analyzing section 201 multiplies parameters for the processing with degrees of freedom and multiplying the parameters multiplied with the degree of importance together.

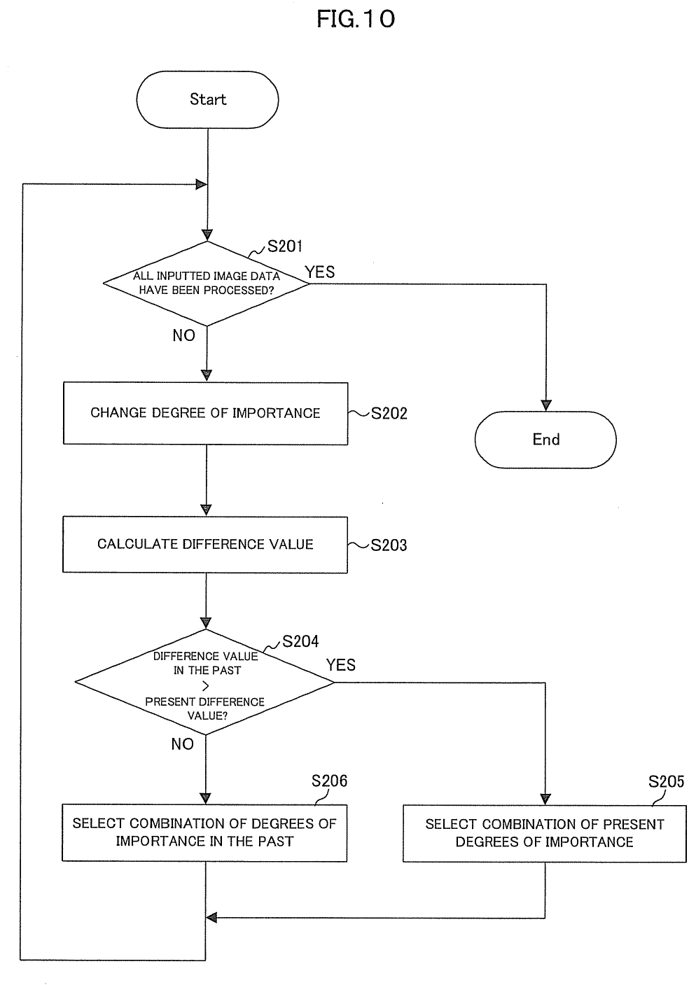

Degree-of-importance determining processing according to this embodiment is explained. FIG. 10 is a flowchart showing operations of the degree-of-importance determining processing.

First, the degree-of-importance determining section 206 determines whether all inputted image data have been processed (S201).

When all the inputted image data have not been processed (S201, NO), the degree-of-importance determining section 206 selects any one of parameters among the parameters for the processing for each of the areas and changes a degree of importance of the selected parameter (S202). The parameter may be selected at random or may be selected according to predetermined order.

When the degree of importance is changed and the processing for the respective areas forming the image data is performed by the image processing section 202 and the OCR processing section 203, the degree-of-importance determining section 206 acquires processing amounts of a PE having a largest processing load and a PE having a smallest processing load in this processing, which are measured in the PEs 101 to 104 by the processing-time measuring section 204, and calculates a difference between the processing amounts as a difference value (S203).

After calculating the difference value, the degree-of-importance determining section 206 compares a difference value in processing of image data inputted immediately before this processing (a difference value in the past) and the difference value calculated in step S203 (a present difference value) and determines whether the difference value in the past is larger than the present difference value (S204). The difference value in the past in this determination does not have to be the difference value in the processing of the image data inputted immediately before this processing and may be a difference value in processing of image data inputted earlier. The degree-of-importance determining section 206 can select a combination of better degrees of importance by referring to records in the past.

When the difference value in the past is larger than the present difference value (S204, YES), the degree-of-importance determining section 206 selects a combination of present degrees of importance (S205).

On the other hand, when the difference value in the past is equal to or smaller than the present difference value (S204, NO), the degree-of-importance determining section 206 selects a combination of degrees of importance in the processing of the image data immediately before this processing (S206).

As explained above, degrees of importance are added to respective parameters for processing of areas forming image data, the degrees of importance are changed every time processing for the image data is performed, and a combination of degrees of importance having lower difference in processing time among PEs is selected. Consequently, for example, since the image data of the same layout structure are continuously inputted, scheduling is gradually optimized and the processing for the image data can be more efficiently executed.

In the embodiments described above, when processing time for image data is shorter than processing time for scheduling, the scheduling does not have to be performed. As the PEs 101 to 104, PEs specialized for performing specific processing such as binary image processing, color image processing, and bit operation processing may be used. Processing for one area may be shared by the plural PEs 101 to 104. In the embodiments, it is assumed that the operations are executed in the MFP. However, the operations may be executed on, for example, a personal computer that includes a multiprocessor and is connected to a scanner.

The present invention has been explained in detail with reference to the specific embodiments. However, it would be obvious for those skilled in the art that various alterations and modifications of the embodiments can be made without departing from the spirit and the scope of the present invention.

As described above, according to the present invention, it is possible to provide a technique that can efficiently allocate processing for respective areas extracted by a layout analysis to plural calculation resources.

What is claimed is:

1. An image forming apparatus that processes image data using plural processors that operate in parallel, the image forming apparatus comprising:
an image-data receiving section configured to receive inputted image data;
a layout analyzing section configured to analyze a layout structure including a predetermined area on the basis of the image data received by the image-data receiving section;
a processing-amount calculating section configured to calculate a processing amount for the predetermined area in the layout structure of the image data analyzed by the layout analyzing section; and
a processing-processor determining section configured to allocate, in processing for all areas in the layout structure analyzed by the layout analyzing section, processing for the predetermined areas to any one of the plural processors on the basis of the processing amount calculated by the processing-amount calculating section.

2. An image forming apparatus according to claim 1, wherein the processing-amount calculating section calculates a processing amount for the predetermined area on the basis of a parameter for the predetermined area.

3. An image forming apparatus according to claim 1, wherein the processing-processor determining section allocates processing for the predetermined area to any one of the plural processors to minimize a difference in a processing amount among the plural processors.

4. An image forming apparatus according to claim 2, further comprising a degree-of-importance changing section configured to change a degree of importance that is a weighting coefficient for the parameter for the predetermined area.

5. An image forming apparatus according to claim 4, further comprising a processing-time measuring section configured to measure, in processing for all the areas in the layout structure analyzed by the layout analyzing section, processing time in each of the plural processors of processing for all the areas allocated to the plural processors by the processing-processor determining section, wherein
the degree-of-importance changing section compares a difference value in the past that is a difference between processing times of a processor having shortest processing time and processing time of a processor having longest processing time in the plural processors measured by the processing-time measuring section before the change of the degree of importance and a present difference value that is a difference between processing times of a processor having shortest processing time and a processor having longest processing time in the plural processors measured by the processing-time measuring section after the change of the degree of importance, sets the degree of importance after the change as a degree of importance when the difference value in the past is larger than the present difference value, and sets the degree of importance before the change as a degree of importance when the difference value in the past is equal to or smaller than the present difference value.

6. An image forming apparatus according to claim 1, wherein a type of the predetermined area is a character or an image.

7. An image processing apparatus that processes image data using plural processors that operate in parallel, the image processing apparatus comprising:
an image-data receiving section configured to receive inputted image data;
a layout analyzing section configured to analyze a layout structure including a predetermined area on the basis of the image data received by the image-data receiving section;
a processing-amount calculating section configured to calculate a processing amount for the predetermined area in the layout structure of the image data analyzed by the layout analyzing section; and
a processing-processor determining section configured to allocate, in processing for all areas in the layout structure analyzed by the layout analyzing section, processing for the predetermined area to any one of the plural processors on the basis of the processing amount calculated by the processing-amount calculating section.

8. An image processing apparatus according to claim 7, wherein the processing-amount calculating section calculates a processing amount for the predetermined area on the basis of a parameter for the predetermined area.

9. An image processing apparatus according to claim 7, wherein the processing-processor determining section allocates processing for the predetermined area to any one of the plural processors to minimize a difference in a processing amount among the plural processors.

10. An image processing apparatus according to claim 8, further comprising a degree-of-importance changing section configured to change a degree of importance that is a weighting coefficient for the parameter for the predetermined area.

11. An image processing apparatus according to claim 10, further comprising a processing-time measuring section configured to measure, in processing for all the areas in the layout structure analyzed by the layout analyzing section, processing time in each of the plural processors of processing for all the areas allocated to the plural processors by the processing-processor determining section, wherein
the degree-of-importance changing section compares a difference value in the past that is a difference between processing times of a processor having shortest processing time and processing time of a processor having longest processing time in the plural processors measured by the processing-time measuring section before the change of the degree of importance and a present difference value that is a difference between processing times of a processor having shortest processing time and a processor having longest processing time in the plural processors measured by the processing-time measuring section after the change of the degree of importance, sets the degree of importance after the change as a degree of importance when the difference value in the past is larger than the present difference value, and sets the degree of importance before the change as a degree of importance when the difference value in the past is equal to or smaller than the present difference value.

12. An image processing apparatus according to claim 7, wherein a type of the predetermined area is a character or an image.

13. An image processing method for processing image data using plural processors that operate in parallel, the image processing method comprising:
receiving inputted image data;
analyzing a layout structure including a predetermined area on the basis of the received image data;
calculating a processing amount for the predetermined area in the analyzed layout structure of the image data; and
allocating, in processing for all areas in the analyzed layout structure, processing for the predetermined area to any one of the plural processors on the basis of the calculated processing amount.

14. An image processing method according to claim 13, wherein a processing amount for the predetermined area is calculated on the basis of a parameter for the predetermined area.

15. An image processing method according to claim 13, wherein processing for the predetermined area is allocated to any one of the plural processors to minimize a difference in a processing amount among the plural processors.

16. An image processing method according to claim 14, further comprising changing a degree of importance that is a weighting coefficient for the parameter for the predetermined area.

17. An image processing method according to claim 16, further comprising:
measuring, in processing for all the areas in the analyzed layout structure, processing time in each of the plural processors of processing for all the areas allocated to the plural processors; and
comparing a difference value in the past that is a difference between processing times of a processor having shortest processing time and processing time of a processor having longest processing time in the plural processors measured before the change of the degree of importance and a present difference value that is a difference between processing times of a processor having shortest processing time and a processor having longest processing time in the plural processors measured after the change of the degree of importance, setting the degree of importance after the change as a degree of importance when the difference value in the past is larger than the present difference value, and setting the degree of importance before the change as a degree of importance when the difference value in the past is equal to or smaller than the present difference value.

18. An image processing method according to claim 13, wherein a type of the predetermined area is a character or an image.
